(19) United States
(12) Patent Application Publication
(10) Pub. No.: US 2012/0034086 A1
(43) Pub. Date: Feb. 9, 2012

(54) SWING AXIAL ENTRY DOVETAIL FOR STEAM TURBINE BUCKETS

(75) Inventors: Prasad Mishrikotkar, Buldhana (IN); Prashant Bhokardole, Bangalore (IN)

(73) Assignee: General Electric Company

(21) Appl. No.: 12/849,900

(22) Filed: Aug. 4, 2010

(51) Int. Cl. F01D 5/30; B23P 15/04

(52) U.S. Cl. 416/219 R; 29/889.21

(57) ABSTRACT

An arrangement and a method for mounting articulated turbine buckets in axial entry slots of rotor wheels. A curvature on a vertical plane may be incorporated on a swing axial-entry male dovetail projection of the bucket root and the associated swing axial-entry female dovetail slot of the rotor wheel. The curvature facilitates loading of buckets otherwise precluded by interferences, such as interlocking tip shrouds on adjacent buckets. Such loading may be provided by locating the shroud tip shroud in proximity to an adjacent tip shroud and pivoting the root end of the swing axial-entry bucket around the location of the tip shroud such that the arc formed by the bucket allows the curvature of the swing axial-entry male dovetail projection to swing into the swing axial-entry female dovetail slot of the rotor wheel.

### BACKGROUND OF THE INVENTION

The invention relates generally to turbomachines and more specifically to an arrangement and a method for mounting articulated turbine buckets in axial entry slots of rotor wheels of the turbomachines.

Rotors for turbomachines are often machined from large forgings. Rotor wheels cut from the forgings are often slotted to accept the roots of turbomachine buckets for mounting. As the demand for greater turbomachine output and more efficient turbomachine performance continues to increase, larger and more articulated turbomachine buckets are being placed into service.

The foregoing factors are of particular importance in relation to last-stage steam turbine buckets having improved aerodynamic, thermodynamic and mechanical properties. Last-stage buckets for turbines have for some time been the subject of substantial developmental work. It is highly desirable to optimize the performance of these buckets to reduce aerodynamic losses and to improve the thermodynamic performance of the turbine. The buckets are exposed to a wide range of flows, loads and strong dynamic forces. Factors that affect the final bucket profile design include the active length of the bucket, the pitch diameter and the high operating speed in both supersonic and subsonic flow regions. Damping and bucket fatigue are factors which must also be considered in the mechanical design of the bucket and its profile. These mechanical and dynamic response properties of the buckets, as well as others, such as aero-thermodynamic properties or material selection, all influence the optimum bucket profile. The turbine buckets require, therefore, a precisely defined bucket profile for optimal performance with minimal losses over a wide operating range. The bucket may often include complex blade geometry with overhang.

Adjacent turbine buckets on a rotor wheel are typically connected together by some form of cover bands or shroud bands around the periphery to confine the working fluid within a well-defined path and to increase the rigidity of the buckets. The interlocking shrouds may often present interferences in assembling buckets on the rotor wheel.

Often rotor wheels incorporate axial entry dovetail slots that accommodate bucket with roots that include complimentary axial entry dovetails. Such axial entry dovetails may be desirable, as they may not require use of external closure pieces or assembly fixtures.

FIG. 1 illustrates a prior art turbine bucket with dovetail that may be axially loaded into a dovetail slot of a rotor wheel. The turbine bucket 10 includes a vane 20, a tip shroud 30 and a platform 40 with a root 45. The root 45 may include a dovetail projection 50 adapted for axial entry into a complimentary dovetail slot 60 of a rotor wheel 65. In some bucket arrangements and particularly for large last stage buckets, at least one slot spring (not shown) may be provided in a space at an inner radial end of the dovetail slot of the rotor wheel. The slot spring may apply an outward radial force on the underside of the dovetail projection that maintains the turbine bucket rigid under low speed conditions such as jacking, thereby limiting wear on the surfaces of the dovetail.

FIG. 2 illustrates a prior art turbine rotor wheel assembly 70 loaded with axial entry dovetailed turbine buckets 10. The male dovetail projections 50 of the turbine buckets 10 are axially loaded sequentially onto the rotor wheel 65 allowing the adjacent platforms 45, tip shrouds 30 and vanes 20 to be installed without interference. However, a last bucket being installed will often present an interference of overlapping vanes 20 that needs to be accommodated with a special closure piece or with trimmed edges.

Accordingly, it would be desirable to provide a bucket arrangement and methods for facilitating loading of axial-entry articulated buckets onto rotor wheels for turbomachines.

### BRIEF DESCRIPTION OF THE INVENTION

According to a first aspect of the present invention, a swing axial-entry arrangement for buckets of a steam turbine is provided. The arrangement includes swing axial-entry buckets where each bucket includes a root arranged for swing axial-entry into a rotor wheel. A dovetail projection on the root of each bucket includes a curvature in a vertical plane. The rotor wheel includes corresponding swing axial-entry dovetail slots around a periphery with each slot complimentary to the dovetail projection for each bucket and includes a curvature in the vertical plane.

According to a second aspect of the present invention, a steam turbine including a rotor wheel with a plurality of swing axial-entry dovetail slots and buckets with a plurality of complimentary swing axial-entry dovetail projections on a root of the buckets is provided. The buckets for the steam turbine include a curvature in a vertical plane on the dovetail projection for the root of each bucket. The swing axial-entry dovetail slots cut on the rotor wheel also include a corresponding curvature in a vertical plane.

A further aspect of the present invention provides a method for assembling a plurality of buckets with swing axial-entry dovetail projections and tip shrouds onto a rotor wheel with a plurality of complimentary swing axial-entry dovetail slots. The method includes providing a rotor wheel with swing axial-entry dovetail slots including a curvature in a vertical plane and buckets with axial-entry dovetail slots including a corresponding curvature in the vertical plane. A bucket is disposed with a tip shroud at a mounting position. The bucket is pivoted at a pivot point in proximity to the tip shroud and swung around the pivot point to assemble the swing axial-entry dovetail projection into a swing axial-entry dovetail slot.

### BRIEF DESCRIPTION OF THE DRAWING

These and other features, aspects, and advantages of the present invention will become better understood when the following detailed description is read with reference to the accompanying drawings in which like characters represent like parts throughout the drawings, wherein:

FIG. 1 illustrates a prior art turbine bucket with dovetail that may be axially loaded into a dovetail slot of a rotor wheel;

FIG. 2 illustrates a prior art turbine rotor wheel assembly loaded with axial entry dovetailed buckets;

FIG. 3 illustrates a radius of curvature for hooks and grooves of a swing axial-entry dovetail bucket;

FIG. 4 illustrates an expanded axial view of root of the bucket showing curvature of the hooks and the grooves;

FIG. 5 illustrates a cutaway cross-section of the complimentary hooks and grooves of female dovetail slot of the rotor wheel;

FIG. 6 provides a partial circumferential view looking inward radially of a straight-type entry into the rotor wheel slots;

FIG. 7 illustrates a partial circumferential view looking inward radially at a skewed-axial type entry into the rotor wheel slots;

FIG. 8 illustrates a side view for an installation of a swing axial-entry dovetail bucket into a rotor wheel;

FIG. 9 illustrates a flowchart for a method of assembling the swing axial-entry dovetailed buckets onto the swing axial-entry dovetailed slots of the rotor wheel; and

FIG. 10 illustrates a last swing axial-entry dovetailed bucket being installed in a complimentary dovetail slot on a rotor wheel between previously installed swing axial-entry dovetail buckets.

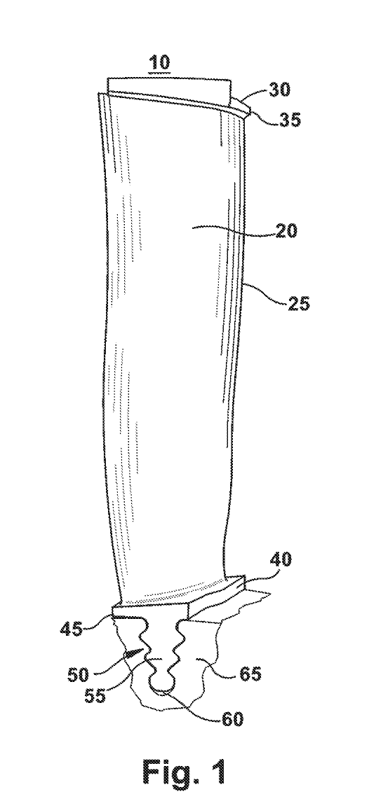

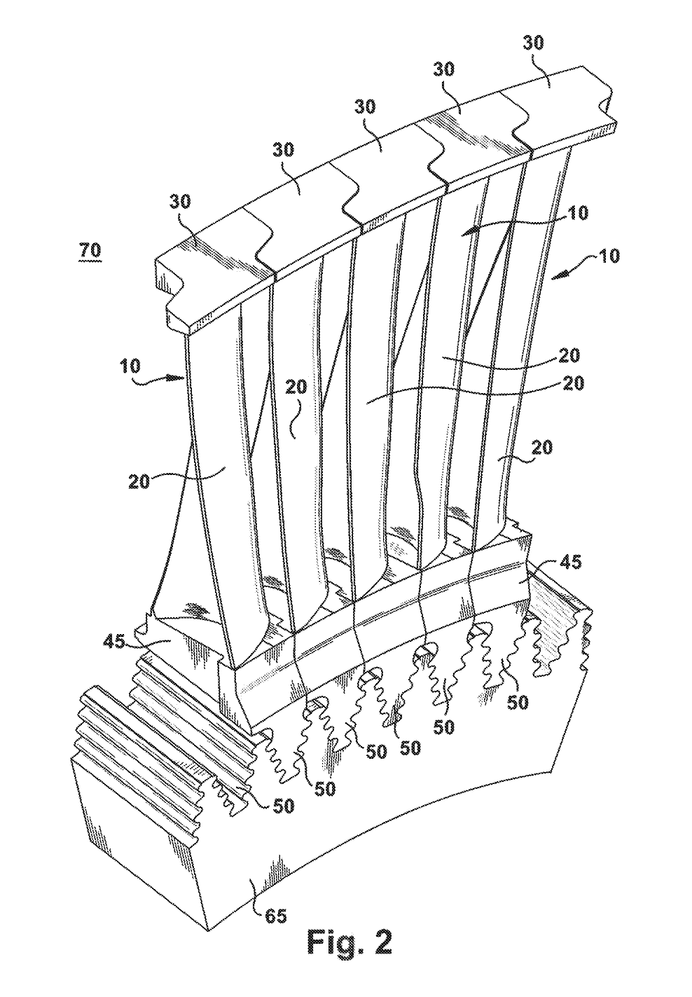

### DETAILED DESCRIPTION OF THE INVENTION

The following embodiments of the present invention have many advantages, including facilitating loading for axial entry dovetailed buckets with interlocking tip shrouds onto rotor wheels. According to an embodiment of the present invention, a curvature on a vertical plane may be incorporated on a swing axial-entry male dovetail projection of the bucket root and the associated swing axial-entry female dovetail slot of the rotor wheel. The curvature facilitates loading of buckets that otherwise might be precluded by interferences, such as interference of interlocking tip shrouds on adjacent buckets. Such loading may be provided by locating the shroud tip shroud in proximity to an adjacent tip shroud and pivoting the root end of the bucket around the location of the tip shroud such that the arc formed by the bucket allows the curvature of the axial male dovetail projection to swing into the curvature of the axial female dovetail slot of the rotor wheel, hence leading to the description of a swing-axial entry bucket. Stress concentrations at dovetail edges can also be reduced. Implementation of curvature on the dovetails does not restrict the tip shroud configuration or the mid-span configuration for bucket. Use of the inventive dovetail arrangement allows the design of the tip shrouds to not be limited by assembly constraints, thereby providing enhanced blade performance. The arrangement may further allow elimination of an assembly fixture for mounting the buckets on the rotor wheel. Further, springs currently required on some axial entry dovetails may be eliminated.

According to an embodiment of the present invention, a dovetail curvature is provided in a plane parallel to the dovetail for a swing axial-entry male dovetail projection of a bucket and a swing axial-entry female dovetail slot. Such curvature is most desirably employed for easing assembly of long, axial-entry buckets. The dovetail is provided with a curvature in vertical plane such that the center of curvature lies near the tip shroud or cover of the bucket. The curvature would have a radius approximately equal to distance between dovetail and bucket tip (approximating the active length). The axial dovetail slot is provided with a similar curvature, whose radius can be varied slightly such that location of initial contact between bucket and wheel crush surfaces can be controlled. The dovetail curvature is in a plane parallel to dovetail and includes a bucket radial line, thus helping to swing it easily during assembly with wheel. The curvature of the dovetails may be applied to straight axial entry buckets and to skewed axial entry buckets and their associated dovetail slots of the rotor wheel.

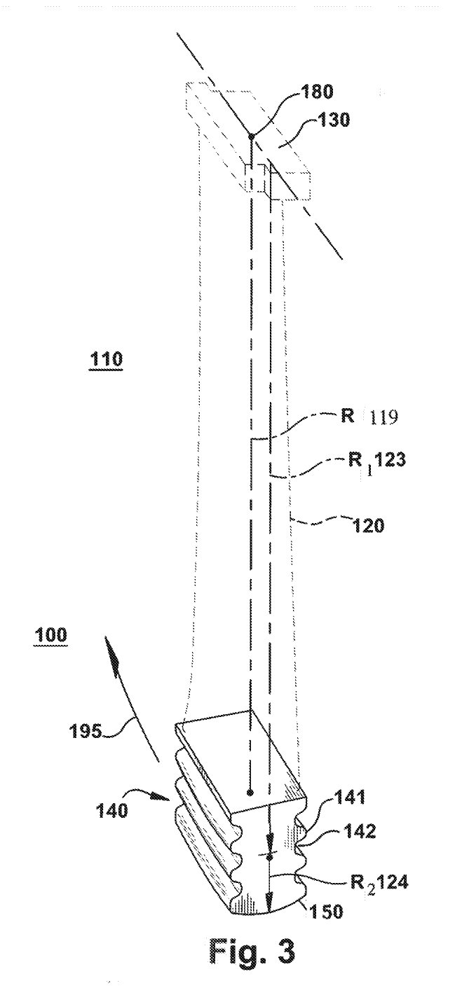

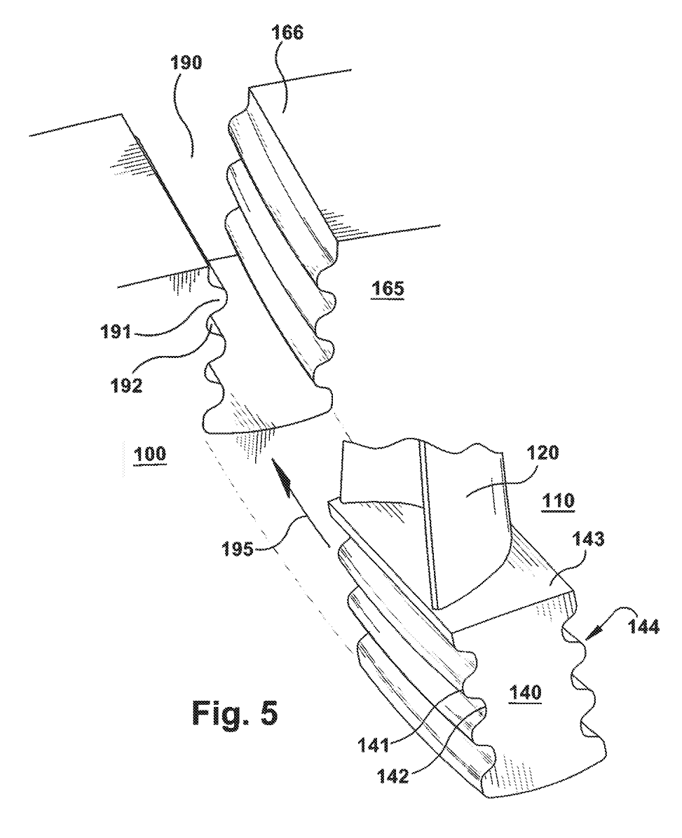

FIG. 3 illustrates a radius of curvature for hooks and grooves of a swing axial-entry dovetail bucket for a steam turbine. The swing axial-entry dovetail bucket 110 includes a vane 120 with a tip shroud 130 and a root 140. A dovetail 150 on the root 140 includes multiple hooks 141 with grooves 142 interspersed therebetween. The radius of curvature R 119 extends from a point 180 in proximity of the tip shroud 130 to the root 140. The swing axial-entry dovetail bucket 110 may be swung 195 around the pivot point 180 for entry into slots 190 of the rotor wheel 165 (FIG. 5). The individual hooks 141 and individual grooves 142 on an individual bucket dovetail (and corresponding hooks and grooves of slot 190 in rotor wheel 165—FIG. 5) will be cut with different curvature dependent on the specific radial distance from the pivot point 130 at the center of curvature as represented by radius R₁ 123 and radius R₂ 124.

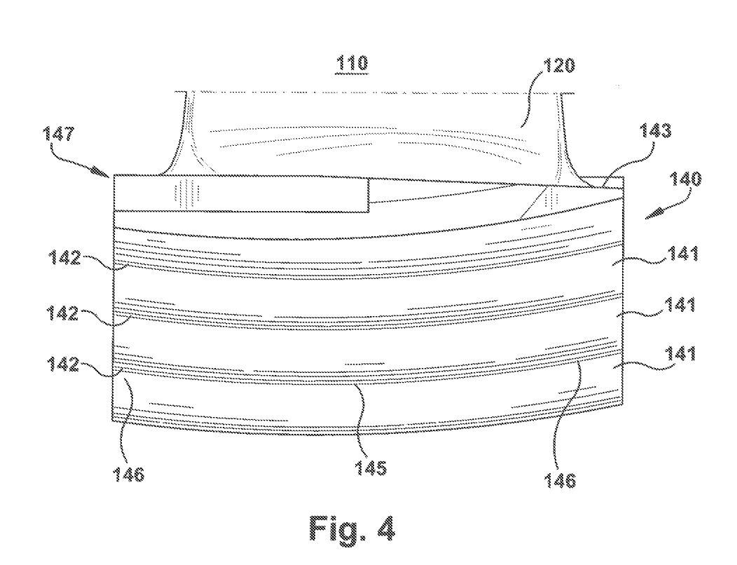

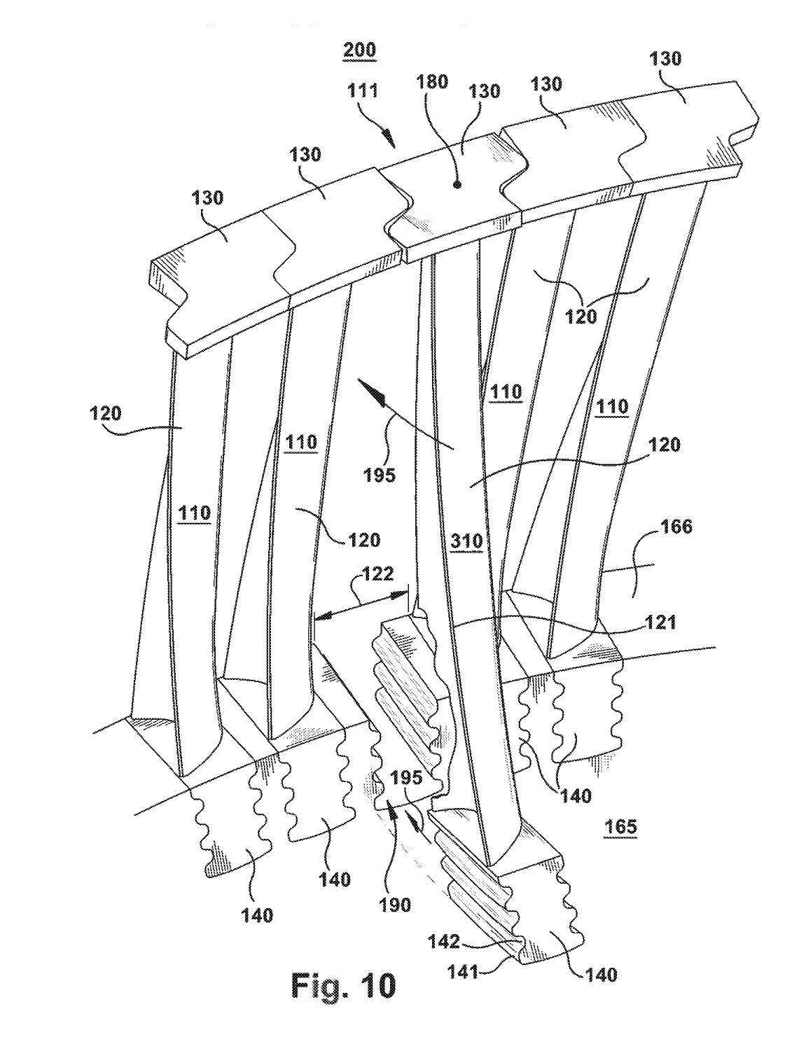

FIG. 4 illustrates an expanded axial view of root 140 of the bucket 110 showing curvature of the hooks 141 and the grooves 142. The embodiment of the invention includes three hooks 141 and three grooves 142 below the platform 143, although other numbers and arrangements of hooks and grooves may be contemplated within the scope of the present invention. The outer surface 147 of platform 143, when the bucket 110 mounted to the rotor wheel 165 (FIG. 10), may form a continuous outer radial surface 166 of the rotor wheel.

By keeping the dovetail curvature radius of the rotor wheel slightly less than bucket dovetail curvature, it can be ensured that initial contact between bucket and wheel dovetail would occur at center 145 of dovetail, and contact spreads towards edges 146 as bucket load increase during turbine operation. Curvatures may be designed for elimination of slot springs. With an appropriate curvature difference between bucket dovetail and the wheel dovetail, three-point contact can be achieved, where one point of contact is provided on a contact surface and two points of contract are provided on non-contact surfaces. Clearances between cover non-contact surfaces as well as contact surfaces may be designed to provide enough space to accommodate cover rotation over a small angle. Further, the wheel dovetail curvature can be optimized to modify stress distribution to the requirements for a specific application.

FIG. 5 illustrates a perspective view of swing axial-entry arrangement 100 of root 140 with hooks 141 and grooves 142 of swing axial-entry bucket 110 being swung 195 into engagement with the complimentary hooks 191 and grooves 192 of female dovetail slot 190 of the rotor wheel 165. Top surface 143 of platform for root 140 may align with outer radial surface 166 of rotor wheel 165.

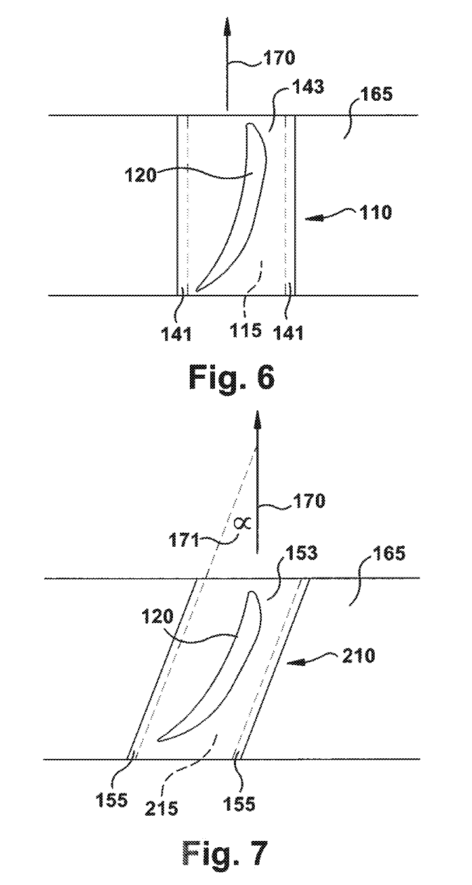

The swing axial-entry dovetails may be employed for straight type entry into axial-oriented slots of the rotor wheel and also for skewed-axial type entry. FIG. 6 provides a partial circumferential view looking inward radially of a straight-type swing axial-entry on rotor wheel 165. The platform 143, the hooks 141 and the grooves (not shown) of the root 140 of the swing axial-entry bucket 110 are oriented within in the rotor wheel 165 in an axial direction 170. FIG. 7 illustrates a partial circumferential view looking inward radially at a skewed-axial type swing axial-entry bucket 210 for mounting into a skewed rotor wheel slot 215. The platform 153, the hooks 155, and the grooves (not shown) of the root of bucket 210 may be skewed at an angle α 171 with respect to the axial direction 170.

For a straight entry type swing axial-entry dovetailed buckets having vane overhang at a trailing edge, the last bucket can be assembled by trimming the trailing edge 121 (FIG. 10) of the last bucket. Such trimming may allow use of current assembly fixtures to be eliminated. Further, conflicts during last bucket assembly at the trailing edge may be addressed by using a large rotor wheel dovetail pitch 122 (FIG. 10), so that extra space is provided for last bucket insertion. This extra space on the rotor wheel will help to reduce vane interferences. Further for the swing axial-entry dovetail arrangements, ease in assembly is provided, as bucket fanning is not required.

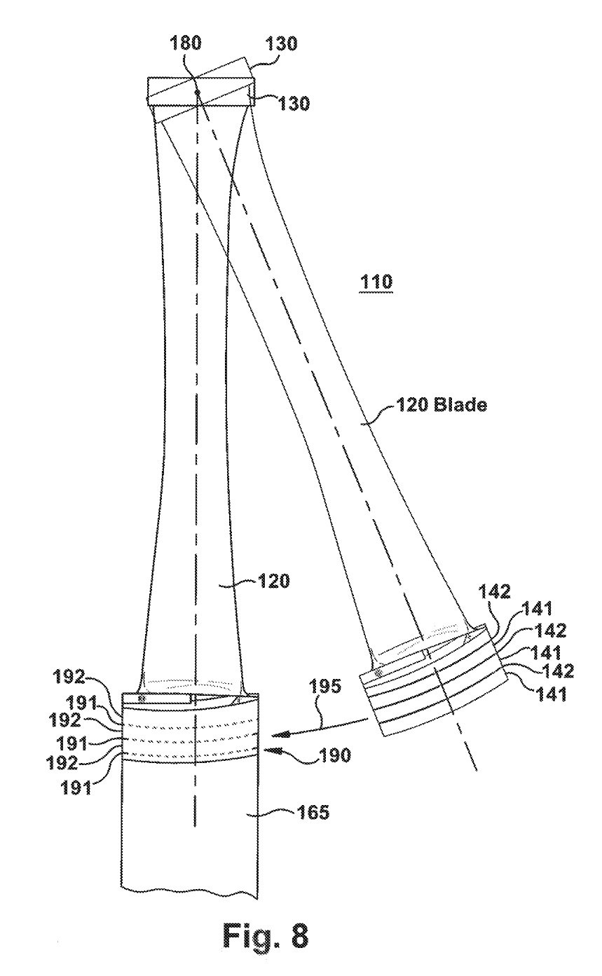

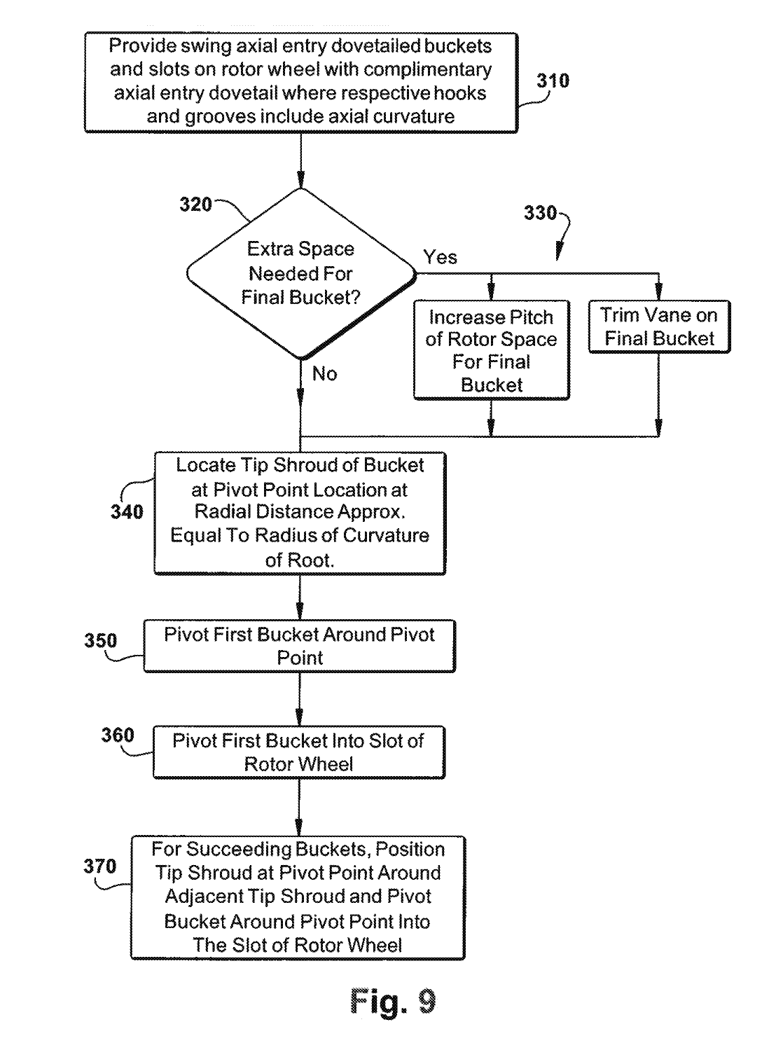

FIG. 8 illustrates a side view for an installation of a swing axial-entry dovetail bucket 110 with curved hooks 141 and curved grooves 142 into slot 190 of a rotor wheel 165. The tip shroud 130 of the bucket 110 is positioned above the rotor wheel 165 with hooks 191 and grooves 192 complimentary to the hooks 141 and grooves 142 of bucket 110. The tip shroud 130 is located at a pivot point 180 corresponding to a center of radius with the bucket located 110 in proximity to an entrance to female dovetail slot 190 of the rotor wheel 165. By maintaining the tip shroud 130 at the center of the radius 180, the bucket 110 may be swung through an arc 195 into engagement with the female dovetail slot 190. When adjacent buckets (not shown) are already in place on the rotor wheel 165, the tip cover 130 may be first oriented among the tip covers (not shown) for the adjacent buckets, as the tip cover is located to the center of radius 180.

A method is provided for assembling the swing axial-entry dovetailed buckets onto the axial entry dovetailed slots of the rotor wheel. The method avoids interferences of structural parts, such as articulated tip shrouds. The method may eliminate the need for equipment fixtures, heretofore required for mounting conventional axial-entry buckets. FIG. 10 illustrates a flowchart for the method of assembling the swing axial-entry dovetailed buckets onto the axial entry dovetailed slots of the rotor wheel. Step 310 provides a rotor wheel with swing axial-entry dovetail slots including a curvature in a vertical plane and buckets with swing axial-entry dovetail roots including a corresponding curvature in the vertical plane. With appropriate curvatures between bucket and wheel dovetails, three point contact between bucket and wheel hooks can be achieved. This ensures contact between bucket and wheel dovetails in cold condition. For skewed type dovetail vane interferences issues during bucket swinging (while assembling) could be addressed by modification to vane trailing edge

According to the specific application, Step 320 may provide a last bucket space on the rotor wheel with a larger pitch adapted to accommodate vane interferences. In Step 330, a blade for a last bucket to be assembled may be provided with a trimmed trailing edge to avoid interference.

Step 340 provides for locating a first bucket in a position such that a tip shroud is located in proximity to its final mounted position at a pivot point that is radially outward from curved surfaces hooks and grooves of the bucket root and spaced apart at a distance approximately equal to the radius of curvature. Step 350 provides for pivoting the first bucket at a pivot point at the tip shroud. In step 360, the dovetail of the first bucket is rotated around the pivot point to assemble the swing axial-entry dovetail projection into an axial-entry dovetail slot. Step 370 assembles succeeding buckets with swing axial-entry dovetail projections onto the rotor wheel into succeeding swing axial-entry dovetail slots in accordance with Steps 340-350. Because the tip shrouds for the assembly of the succeeding buckets are initially located at essentially at their final mounted position and only experience a small rotational angle while the swing axial-entry dovetail is mated with the slot in the rotor wheel, the interference with adjacent tip shrouds may be avoided.

FIG. 10 illustrates a steam turbine 200 with last swing axial-entry dovetailed bucket 310 being installed in a complimentary dovetail slot 190 on a rotor wheel 165 between previously installed swing axial-entry buckets 110. The tip shroud 130 of the last bucket 310 is located in proximity to the tip shrouds 130 of the adjacent buckets 110 with the root 140 of the last bucket 310 disposed at a swing angle to radial. The hooks 141 and grooves 142 of the last bucket 310 and the hooks 191 (FIG. 5) and grooves 192 (FIG. 5) of the rotor slot 190 may be cut to a radius (FIG. 3) approximating the active length of the bucket. The tip shroud 130 of the last installed bucket 330 may be rotated in place as the bucket dovetail 140 is swung 195 into rotor slot 190.

While various embodiments are described herein, it will be appreciated from the specification that various combinations of elements, variations or improvements therein may be made, and are within the scope of the invention.

1. A swing axial-entry arrangement for buckets of a steam turbine, the arrangement comprising:
a rotor wheel;
a plurality of swing axial-entry buckets wherein each bucket includes a root arranged for swing axial-entry into the rotor wheel;
a swing axial-entry dovetail projection on the root of each bucket including a curvature in a vertical plane; and
the rotor wheel including a corresponding plurality of swing axial-entry dovetail slots around a periphery wherein each axial cut dovetail slot is complimentary to the swing axial-entry dovetail projection of each bucket and includes a curvature in the vertical plane.

2. The swing axial-entry arrangement according to claim 1, wherein the dovetail projection of each bucket and each dovetail slot on the rotor wheel is cut for a straight axial entry.

3. The swing axial-entry arrangement according to claim 1, wherein the dovetail projection of each bucket and each dovetail slot on the rotor wheel is cut for a skewed axial entry.

4. The swing axial-entry arrangement according to claim 1, wherein the curvature of the dovetail slots of the rotor wheel is set approximately equal to the curvature of the dovetail projection of the bucket.

5. The swing axial-entry arrangement according to claim 4, wherein a location of initial contract between the bucket and contact surfaces of the slots of the rotor wheel is controlled by modifying a radius of the curvature.

6. The swing axial-entry arrangement according to claim 4, wherein the radius of the curvature would be approximately equal to the distance between the dovetail projection of the bucket and a tip cover of the bucket.

7. The swing axial-entry arrangement according to claim 6, wherein a three point contact is established between a plurality of hooks on the dovetail of the bucket and a plurality of grooves on dovetail slots of the rotor wheel according to a curvature difference between the dovetail of the bucket and the dovetail of the rotor wheel.

8. The swing axial-entry arrangement according to claim 7, wherein the three point contact is established at a contact surface and on two non-contact surfaces.

9. A steam turbine including a rotor wheel with a plurality of swing axial-entry dovetail slots and buckets with a plurality of complimentary swing axial-entry dovetail projections on a root of the buckets, comprising:
a curvature in a vertical plane on the swing axial-entry dovetail projection on the root of each bucket including; and
a curvature in the vertical plane on each swing axial-entry dovetail slot on the rotor wheel.

10. The steam turbine according to claim 9, wherein the dovetail of each bucket and each dovetail slot on the rotor wheel is cut for a straight axial entry.

11. The steam turbine according to claim 9, wherein the dovetail of each bucket and each dovetail slot on the rotor wheel is cut for a skewed axial entry.

12. The steam turbine according to claim 9, wherein the curvature of the dovetail slot of the rotor wheel would be set approximately equal to the curvature of the dovetail projection of the bucket.

13. The steam turbine according to claim 12, wherein a location of initial contract between the bucket and crush wheel crush surfaces is controlled by modifying a radius of the curvature.

14. The steam turbine according to claim 12, wherein the radius of the curvature would be approximately equal to the distance between the dovetail of the bucket and a tip of the bucket.

15. The steam turbine according to claim 14, wherein a three point contact is established between a plurality of hooks on the dovetail of the bucket and a plurality of hooks on the rotor wheel hooks according to a curvature difference between the dovetail of the bucket and the dovetail of the rotor wheel

16. A method for assembling a plurality of buckets with swing axial-entry dovetail projections and tip shrouds onto a rotor wheel with a plurality of complimentary swing axial-entry dovetail slots, the method comprising:
providing a rotor wheel with swing axial-entry dovetail slots including a curvature in a vertical plane and buckets with swing axial-entry dovetail slots including a corresponding curvature in the vertical plane;
locating a bucket in a position such that a tip shroud is located at a mounting position;
pivoting the bucket at a pivot point at the tip shroud; and
swinging the bucket around the pivot point to assemble the axial-entry dovetail projection into an axial-entry dovetail slot.

17. The method according to claim 16, further comprising:
assembling succeeding buckets with swing axial-entry dovetail projections of the plurality of buckets onto the rotor wheel into succeeding swing axial-entry dovetail slots of the plurality of dovetail slots.

18. The method according to claim 17, the step of providing further comprises:
providing a last bucket space on the rotor wheel with a larger pitch adapted to accommodate vane interferences.

19. The method according to claim 17, the step of providing further comprises:
providing a blade for a last bucket to be assembled with a trimmed trailing edge.

20. The method according to claim 17, the step of providing further comprises:
incorporating clearances in contact surfaces and non-contact surfaces of the tip shroud to allow for radial swing.
